(19) United States
(12) Patent Application Publication
(10) Pub. No.: US 2017/0303483 A1
(43) Pub. Date: Oct. 26, 2017

(54) Hydroponic Plant Growing Apparatus

(71) Applicant: Tex Ag IP, LLC, Austin, TX (US)

(72) Inventor: Paul Hardej, Austin, TX (US)

(73) Assignee: Tex Ag IP, LLC, Austin, TX (US)

(21) Appl. No.: 15/423,871

(22) Filed: Feb. 3, 2017

Related U.S. Application Data
(63) Continuation-in-part of application No. 15/406,725, filed on Jan. 15, 2017.
(60) Provisional application No. 62/325,173, filed on Apr. 20, 2016.

(51) Int. Cl. A01G 31/02

(52) U.S. Cl. CPC A01G 31/02

(57) ABSTRACT

Provided is an apparatus for hydroponic plant production including a tray; having interior and exterior bottom surfaces; a plurality of drip holes disposed within a bottom portion of the tray, the drip holes passing from the exterior bottom surface of the bottom portion of the tray through to the interior bottom surface; a support medium; a plurality of first spacers configured to suspend the support medium above the interior bottom surface, forming an space between the support medium and the interior bottom surface; and a dome defining an interior volume, the dome disposed above the tray and removably attached thereto; wherein the interior volume is configured to accommodate a plurality of plants growing; and the support medium is configured to provide a matrix supporting roots of the plants and convey a nutrient medium to the roots. Also provided is a grow bed to hold a plurality of claimed trays.

### CROSS-REFERENCES TO RELATED APPLICATIONS

The present application is a Continuation-in-part of and claims the benefit of the filing date of an application entitled, “Hydroponic Plant Growing Apparatus” Ser. No. 15/406,725, filed Jan. 15, 2017, assigned to the assignee of the present application, and herein incorporated by reference, which, claims the benefit of the filing date of a provisional application entitled, “Hydroponic Plant Grow Apparatus” Ser. No. 62/325,173, filed Apr. 20, 2016, assigned to the assignee of the present application, and herein incorporated by reference.

### FIELD OF DISCLOSURE

This disclosure relates to hydroponic growth of plants and, in particular, to apparatus for the efficient hydroponic production of plants, including production for human and animal consumption.

### BACKGROUND OF THE INVENTION

Traditional, related-art hydroponic cultivation systems typically employ large tanks, nutrient flow systems and ventilation systems that are most suited to industrial scale plant production.

### SUMMARY

The principles of the disclosure are directed to scalable hydroponic plant production that may range from commercial-scale operations to production for individual consumers and provide for extended plant shelf life by delivering plants with roots intact.

Provided is an apparatus for hydroponic plant production including a tray; having an interior bottom surface and an exterior bottom surface; a plurality of drip holes disposed within a bottom portion of the tray, the drip holes passing from the exterior bottom surface of the bottom portion of the tray through to the interior bottom surface; a support medium; a plurality of first spacers configured to suspend the support medium above the interior bottom surface, forming an space between the support medium and the interior bottom surface; and a dome defining an interior volume, the dome disposed above the tray and removably attached thereto; wherein the interior volume is configured to accommodate a plurality of plants growing within the apparatus; and the support medium is configured to provide a matrix supporting roots of the plurality of plants and convey a nutrient medium to the roots.

Also provided is an apparatus for hydroponic plant production including a grow bed, a tray, the tray comprising an interior bottom surface, an exterior bottom surface. a plurality of drip holes disposed within a bottom portion of the tray, the drip holes passing from the exterior bottom surface through to the interior bottom surface, a support matrix, a plurality of first spacers, wherein the plurality of first spacers are configured to suspend the support medium above the exterior bottom portion, forming a space between the support matrix and the interior bottom surface, a plurality of second spacers, wherein the plurality of second spacers are configured to suspend the tray above the grow bed, forming a space between the exterior bottom surface and an interior surface of the grow bed, a dome defining an interior volume, the dome disposed above the tray and removably attached thereto; wherein the interior volume is configured to accommodate a plurality of plants growing within the apparatus and the support matrix supports roots of the plurality of plants and conveys a nutrient medium to the roots.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed description.

### BRIEF DESCRIPTION OF THE DRAWINGS

For a detailed description of various embodiments, reference will now be made to the accompanying drawings in which:

FIG. 1 shows a cross-sectional view of a plant growing apparatus, or simply “grow apparatus,” in accordance with at least some embodiments;

FIG. 2 shows a portion of a grow apparatus in further detail in accordance with at least some embodiments;

FIG. 3 shows a cross-sectional perspective view of a portion of a grow apparatus in accordance with at least some embodiments;

FIG. 4 shows a cross-sectional view of a grow apparatus in accordance with some embodiments;

FIG. 5 shows a cross-sectional view of a grow apparatus in accordance with at least some embodiments;

FIG. 6 shows a cross-sectional view of a hydroponic grow system in accordance with at least some embodiments;

FIG. 7 shows a cross-sectional view of another embodiment of a grow apparatus in accordance with the disclosed technology; and

FIG. 8 shows a cross-sectional view of another embodiment of a grow apparatus in accordance with the disclosed technology.

### DETAILED DESCRIPTION

Certain terms are used throughout the following description and claims to refer to particular system components. As one skilled in the art will appreciate, different companies may refer to a component by different names. This document does not intend to distinguish between components that differ in name but not function. In the following discussion and in the claims, the terms “including” and “comprising” are used in an openended fashion, and thus should be interpreted to mean “including, but not limited to . . . .” Also, the term “couple” or “couples” is intended to mean either an indirect or direct connection. Thus, if a first device couples to a second device, that connection may be through a direct connection or through an indirect connection via other devices and connections.

“About” as used herein in conjunction with a numerical value shall mean the recited numerical value as may be determined accounting for generally accepted variation in measurement, manufacture and the like in the relevant industry.

The following discussion is directed to various embodiments. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

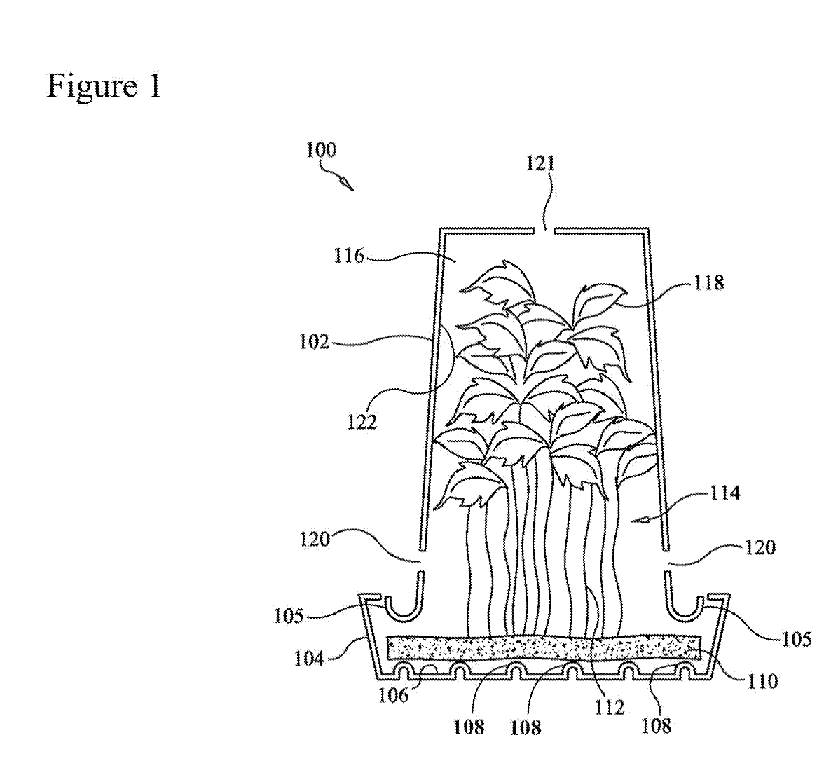

Turning now to FIG. 1, a plant growing apparatus, simply “grow apparatus,” 100 in accordance with at least some embodiments, is shown. Grow apparatus 100 includes a dome 102 and a tray 104. Dome 102 may be fabricated from a transparent or translucent material so that light for photosynthesis may be admitted into grow apparatus 100. Further, dome 102 may allow for the consumer to view the plants within grow apparatus 100. Examples of suitable materials include polystyrene, polyester, polyvinyl chloride (PCV), polyethylene terephthalate (PET), and polyactide (PLA). Dome 102 may be fabricated by any suitable technique, such as thermoforming or injection molding, for example. Dome 102 may be disposed above tray 104 and removably attached thereto by fixtures 105, as described further below.

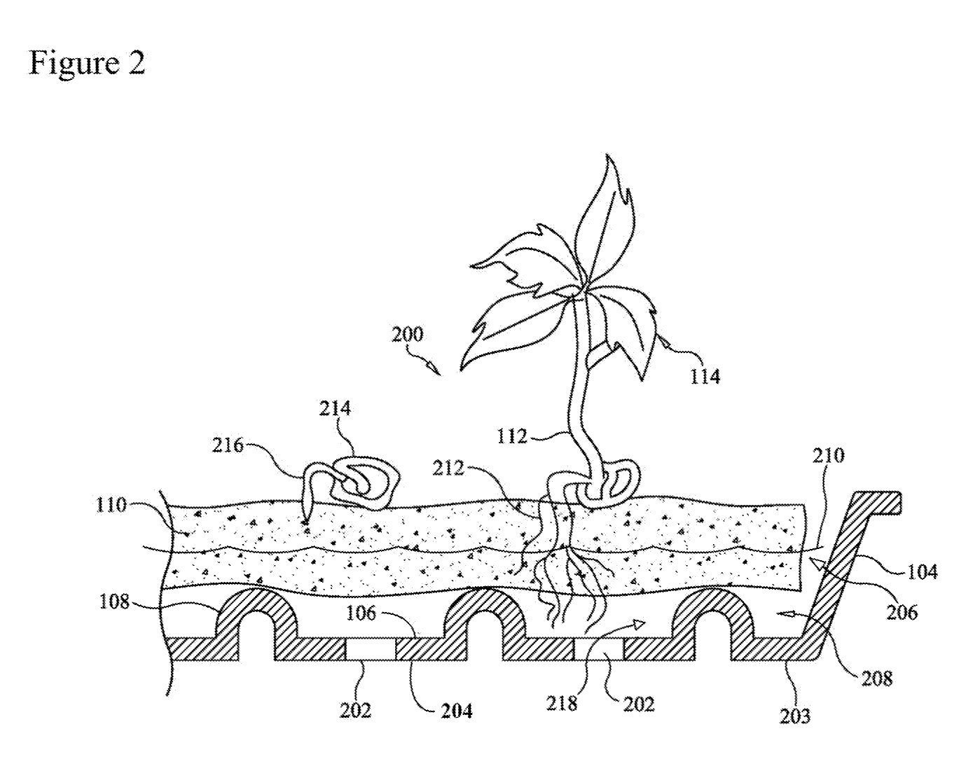

Tray 104 includes an interior bottom surface 106. Corrugations 108 may be formed or disposed upon interior bottom surface 106. Corrugations 108 may thus serve to suspend a growth substrate 110 above interior bottom surface 106. Growth substrate 110 may serve as a matrix to support roots (not shown in FIG. 1; see 212, FIG. 2) attached to stems 112 of plants 114 within grow apparatus 100. Growth substrate 110 may also convey a nutrient medium (not shown in FIG. 1; see 206, FIG. 2) within tray 104 to the roots of plants 114, as described further below. Any suitable horticultural grow substrate may be used. A commercially available example is BIOSTRATE® from Grow-Tech, LLC, South Portland, Me., USA. Other growth substrates may include soil, or aggregates such as peat, vermiculite, polyester beads, perlite, coconut coir, sand, sawdust, fabrics made of organic materials, organic or synthetic sponges, and combinations thereof, including combinations formed by mixing and binding these organic or synthetic materials with binding agents and chemicals to augment the properties of the substrate such as moisture retention.

An interior volume 116 of dome 102 is configured to accommodate leafy portions 118 of plants 114 as the plants grow within grow apparatus 100. Vents 120 and 121 disposed within dome 102 admit air into interior volume 116 and provide for the exhausting of carbon dioxide produced by plants 114 in the course of photosysthesis from the interior volume 116. Thus, air may enter interior volume 116 via vents 120, flow by convection through the interior volume past leafy portions 118, picking up carbon dioxide expelled by leafy portions 118, and exit vent 121 at a top of dome 102. Additionally, water vapor produced by the metabolism of plants 114 and released by transpiration from leafy portions 118 may also be exhausted through vent 121. In this way the humidity in interior volume 116 may be controlled to mitigate against condensation on interior surfaces 122 of dome 102. Any suitable diameter of vent may be used such that the required air flow is achieved. By way of example, a vent diameter greater than one quarter inch (¼″) may be used in at least some embodiments.

FIG. 2 shows a portion 200 of tray 104 (FIG. 1) in accordance with at least some embodiments of grow apparatus 100 (FIG. 1). In portion 200, tray 104 includes one or more drip holes 202 disposed within bottom 203 of tray 104. Drip holes 202 pass between exterior bottom surface 204 and interior bottom surface 106 (FIG. 1) of bottom 203. Drip holes 202 allow for the ingress of nutrient medium 206 into an interior space 208 of tray 104. Further, drip holes 202 allow for the egress of nutrient medium 206 from interior space 208 as nutrient medium 206 is refreshed as described below. Hydroponic nutrient media may include water mixed with minerals and nutrients such as nitrogen, phosphorous and potassium. Various nutrient medium embodiments may include differing amounts of dissolved solutes and dissolved oxygen, based on water temperature, for example. As would be appreciated by those skilled in the art having the benefit of the disclosure, nutrient medium compositions may be adjusted based on the type of material used for the growth substrate because different growth substrates may have varying absorption rates and/or holding capacity, for example.

A level 210 of nutrient medium 206 may be established such that growth substrate 110 (FIG. 1) is not fully submerged in nutrient medium 206. In this way, contact between nutrient medium 206 and stems 112 (FIG. 1) of plants 114 (FIG. 1) may be prevented. However, roots 212 may receive nutrients through contact with nutrient medium 206 via capillary action of growth substrate 110. Growth substrate 110 maintains an adequate moisture level of the plants. Similarly, plants at a seedling stage 214 receive mechanical support from growth substrate 110 and nutrients from nutrient medium 206 in contact with a radicle 216. Further, the suspension of growth substrate 110 above interior bottom surface 106 by corrugations 108 (FIG. 1) provides an air zone 218 upon the draining of nutrient medium 206 from the grow apparatus 100. In this way free oxygen flow may be provided to the plant root mass. Thus, roots 212 that are contained within, penetrate and grow beneath growth substrate 110 may be exposed to oxygen. Oxygen is needed for plant cell respiration. Oxygen in the nutrient medium is absorbed by root cell hairs (not shown in FIG. 2) which also take in nutrients needed by the plants. The oxygen also helps support beneficial organisms, such as certain fungi, that grow on the root hairs. Further, in at least some embodiments, oxygen may be pumped into the nutrient medium or added by mechanical aeration. In other embodiments, oxygen may be added chemically, by for example, adding hydrogen peroxide to the nutrient medium. Saturated dissolved oxygen levels may be in the range from about five parts per million (5 ppm) to about twenty parts per million (20 ppm).

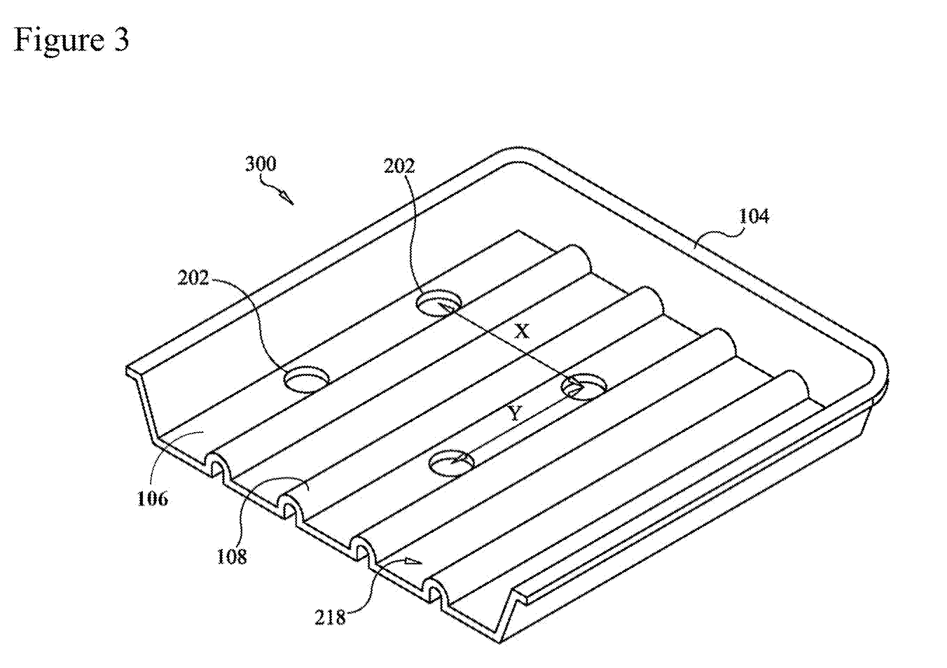

FIG. 3 shows a portion 300 of tray 104 (FIGS. 1 and 2) in a cross-sectional perspective in accordance with at least some embodiments. Corrugations 108 (FIGS. 1 and 2) subdivide the interior bottom surface 106 (FIGS. 1 and 2) into a plurality of air zones 218 (FIG. 2) extending longitudinally along interior bottom surface 106. In at least some embodiments, corrugations 108 may have a height of about 2 millimeters (2 mm) or greater. In this way, space for development of the plant root mass and for circulation of the nutrient medium and oxygen dissolved therein is provided. The spacing of the corrugations 108 may be about 10 millimeters (10 mm) or greater based on the foregoing considerations with a thickness of about 2 millimeters (2 mm), or less. The aforesaid dimensions are by way of example, and other spacings and thicknesses of corrugations 108 may be used based on the materials used in the fabrication of tray 104, accommodation of the development of the plant root mass and circulation of the nutrient medium and dissolved oxygen, as would be appreciated by those skilled in the art having the benefit of the disclosure.

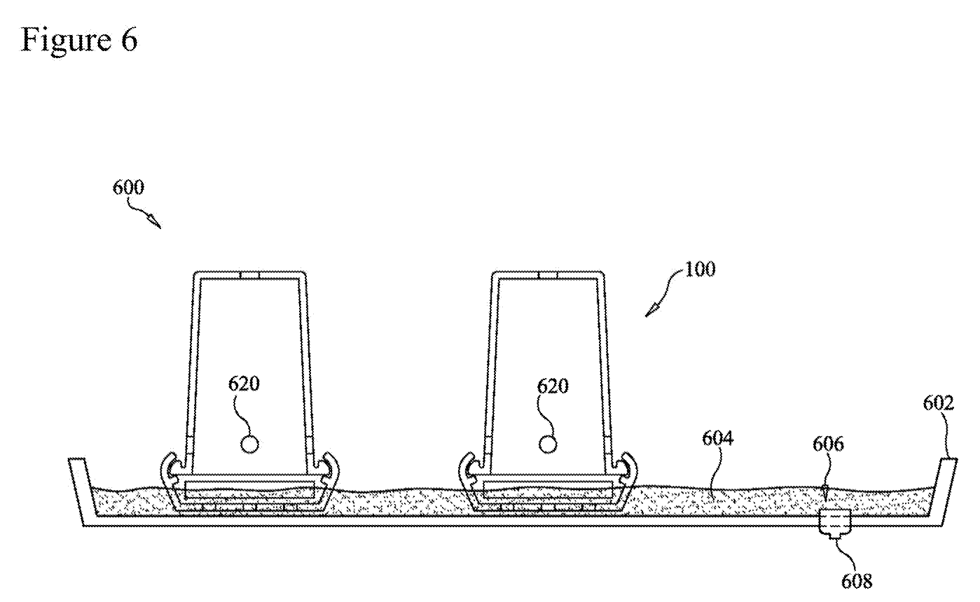

In at least some embodiments, drip holes 202 (FIG. 2) may be disposed within tray 104 in which the drip holes 202 have both a spaced apart relationship in the transverse direction, “X”, and longitudinal direction, “Y”. The numbers and spacing of drip holes 202 may vary in accordance with the dimensions of tray 104. However, in at least some embodiments, at least four drip holes 202 may be used. Further, the distribution of drip holes 202 may be spread evenly across a surface area of interior bottom surface 106 such that a substantially equal distribution of nutrient medium is provided to grow substrate 110 (FIGS. 1 and 2). Further, in at least some embodiments, drip holes 202 may have a diameter in the range of about one-eighth inch (⅛″) to about three-eighths inch (⅜″). The foregoing ranges are exemplary and other suitable spacings and diameters may be used. Stated otherwise, the spacings and diameters of drip holes 202 may be selected so that the nutrient medium is distributed to each corner of the grow apparatus and the grow substrate, and to accommodate a flow rate of the nutrient medium as described further in conjunction with FIG. 6. Further, different compositions of grow substrate 110 may have different rates of absorption and retention rates of nutrient medium 206 (FIG. 2), and the diameters of the drip holes 202 may also be adjusted to accommodate such differences.

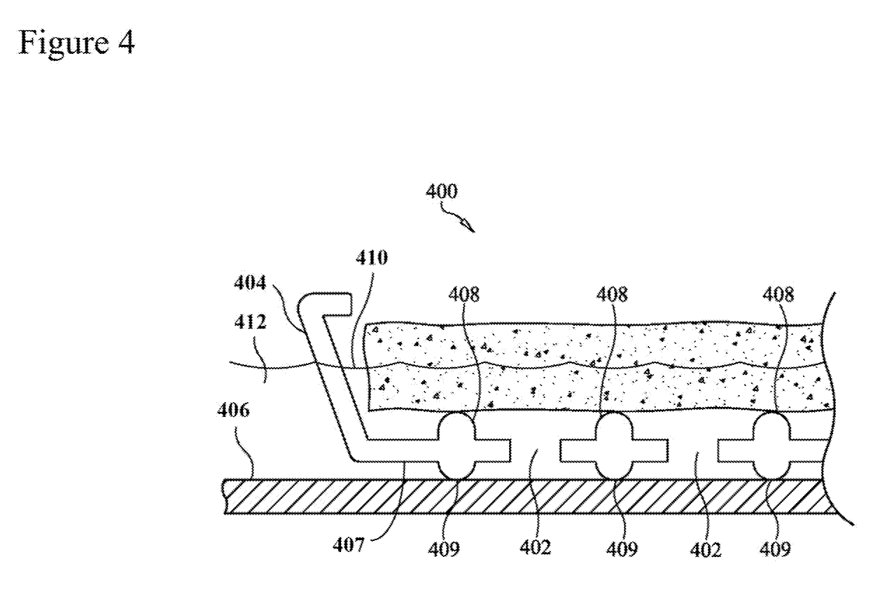

FIG. 4 shows a cross-sectional view of a portion 400 of a tray 404 in accordance with some embodiments. Portion 400 includes corrugations 408 similar to corrugations 108 (FIGS. 1-3) of tray 104 (FIGS. 1-3). Also illustrated is a level 410 of a nutrient medium 412, like level 210 of nutrient medium 206 shown in FIG. 2. Further, tray 404 may include corrugations 409 disposed upon an exterior bottom surface 407 of tray 404. In this way, when a grow apparatus including a tray such as tray 404 is disposed within a grow bed (only the base 406 of which is shown in FIG. 4; see 602, FIG. 6), tray 404 is raised off of grow bed base 406, allowing nutrient medium 412 to flow beneath tray 404, thus helping to substantially continuously supply nutrients and dissolved oxygen to plant roots such as plant roots 212 (FIG. 2) and to enter and exit tray 404 via drip holes 402. In this way, for example, when a grow apparatus comprising a tray 404 is operationally disposed within grow bed 406, nutrient medium 412 may be drained from grow bed 406 and new nutrient medium added without otherwise disturbing grow apparatus 400.

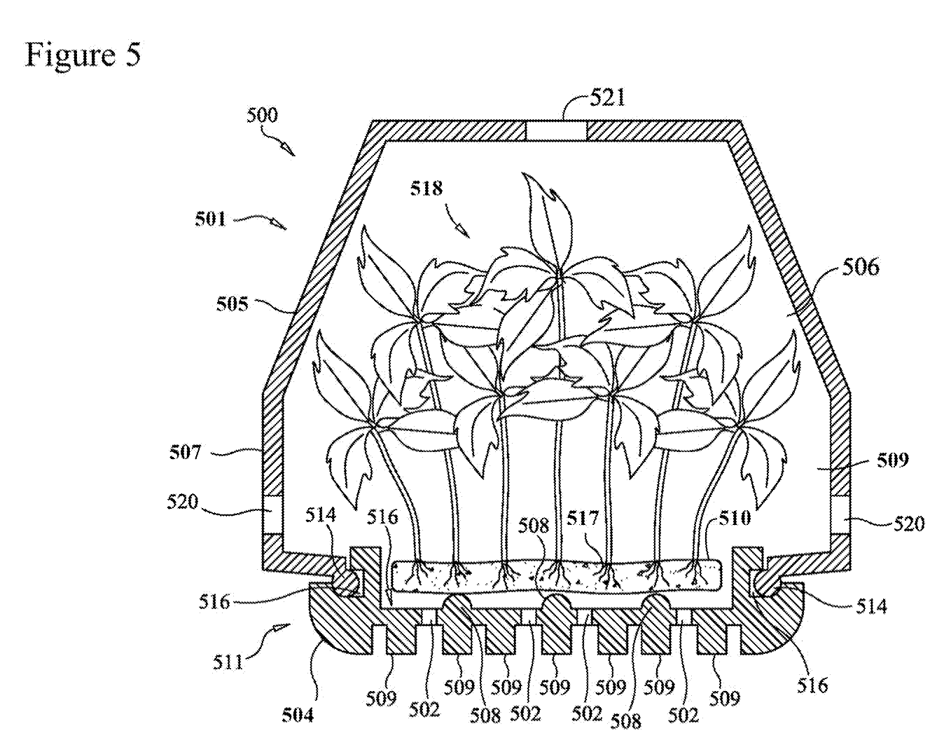

FIG. 5 shows a grow apparatus 500, in a cross-sectional view, in accordance with at least some embodiments. Grow apparatus 500 includes a dome 501 and a tray 504. Dome 501 may comprise materials similar to dome 102 (FIG. 1), and likewise may be transparent or translucent. A sidewall member 505 of dome 501 defines an interior volume portion 506 having a trapezoidal transverse cross section and a sidewall member 507 defines an interior volume portion 509 having a rectangular transverse cross section. In this way plants 518 having differing height may be accommodated while mitigating against wasted volume. In at least some other embodiments, the leaves of plants 518 may be accommodated by a dome having a shape that extends out beyond periphery 511 of the base 504 in a bow-shaped, or bulging configuration. The foregoing embodiments are exemplary and other embodiments having different shapes may be used within the principles of the disclosure.

Dome 501 may be removably attached to a base 504. Base 504 may comprise a plastic material, and may be transparent, translucent, or opaque. By way of example, suitable materials include food-safe, non-soluble materials, for example plastics such as PET, PLA. Base 504 may have different dimensions, depending on the application of grow apparatus 500. For example, in at least some embodiments, base 504 may be 3 inches (3″) by 4 inches (4″) in size. Other embodiments may have sizes of base 504 including 6 inches (6″) by 4 inches (4″), 8 inches (8″) by 5 inches (5″) or 7 inches (7″) by 11 inches (11″). Other sizes may be used appropriate to the specific application, as would be appreciated by those skilled in the art having the benefit of the disclosure.

Dome 501 includes vents 520 and 521 for the ingress of air into the interior volume comprising interior volume portions 506, 509 and the exhausting of carbon dioxide and water vapor therefrom as previously described in conjunction with vents 120 and 121 of grow apparatus 100 of FIG. 1. Dome 501 may be attached to base 504 by fixtures 514. Fixtures 514 may engage respective recesses 516 in base 504 to removably attach dome 501 to base 504.

Similar to growth substrate 110 (FIG. 1) of growth apparatus 100, growth apparatus 500 includes a growth substrate 510 supported on corrugations 508 formed on an interior bottom surface 516 of tray 504. Growth substrate 510 provides for stabilization of root structures 517 of plants 518 and the supply of a nutrient medium (not shown in FIG. 5) to roots 517 via capillary action as described hereinabove.

Base 504 also includes a plurality of corrugations 509. Corrugations 509 may be included to facilitate the flow of a nutrient medium into and out of tray 504 via drip holes 502 as described above in conjunction drip holes 202 with FIG. 2. For example, when growth apparatus 500 is operationally deployed in a grow bed (not shown in FIG. 5) as further described in conjunction with FIG. 6, corrugations 509 may facilitate the replacement or circulation of the nutrient medium.

FIG. 6 shows, in a cross-sectional view, a hydroponic plant grow system 600 in accordance with at least some embodiments. Plant grow system 600 includes a plurality of grow apparatus 100 (FIGS. 1-3) disposed within a grow bed 602. Although two grow apparatus 100 are shown for ease of illustration, any number of grow apparatus may be used, depending on the size of the grow bed 602. Further, although grow apparatus 100 are shown, other grow apparatus, such as grow apparatus 500, may be used in conjunction with hydroponic plant grow system 600. Grow bed 602 may be flooded with a nutrient medium 604 which may then flow into the grow apparatus 100 as previously described. For example, in a grow apparatus such as a grow apparatus 500 having a base with corrugations 509 as described in conjunction with FIG. 5, nutrient medium 604 may flood a number of grow apparatus 500 through drip holes 502 disposed between corrugations 509. Such grow systems may be referred to as a “flood and drain” or “ebb and flow” grow system. In at least some embodiments, a nutrient medium flow rate of from about 10 gallons per minute (10 gpm) to about forty gallons per minute (40 gpm) may be used. In an embodiment, a particular flow rate may be based on a concentration of nutrients and dissolved oxygen in the nutrient medium such that the appropriate nutrient and oxygen volume is delivered to the plants.

A height of corrugations such as corrugations 509 (FIG. 5) may be such that the aforesaid flow of the nutrient medium is not restricted by the friction of the nutrient medium against the surface of the corrugations 509 during the ingress and egress of the nutrient medium through drip holes 502 (FIG. 5). In this way, an appropriate nutrient and dissolved oxygen delivery to the plant root zone may be maintained. Grow bed 602 may be equipped with a drain hole 606 and removable plug 608 to facilitate replacement of nutrient medium 604. As nutrient medium 604 is drained from grow bed 602, the nutrient medium that has flooded grow apparatus 100 will also drain back into grow bed 602 and then out the drain hole 606. Although only one drain hole 606 is shown for ease of illustration, multiple drain holes may be used. Alternatively, other mechanisms to drain nutrient medium 604 from grow bed 602 may be used, such as siphons, for example. Also included in FIG. 6 are vent holes 620 that provide a function similar to vent holes 120 (FIG. 1).

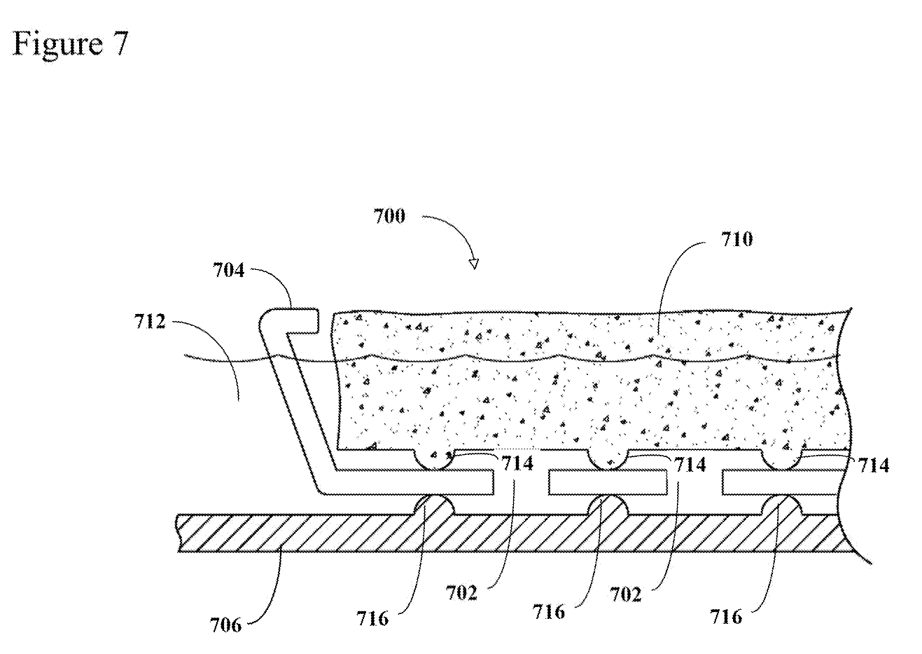

FIG. 7 shows a cross-sectional view of a portion 700 of a tray 704 in accordance with some embodiments. Like portion 400 of FIG. 4, portion 700 includes a nutrient medium 710, a portion of a base 706 and drip holes 702 that enable a nutrient medium 712 to be refreshed and drained from tray 704. In this embodiment, a growth substrate 710 includes corrugations 714 that provide a space between growth substrate 710 and grow tray 704. Corrugations 716 on base 706 provide space between tray 704 and base 706.

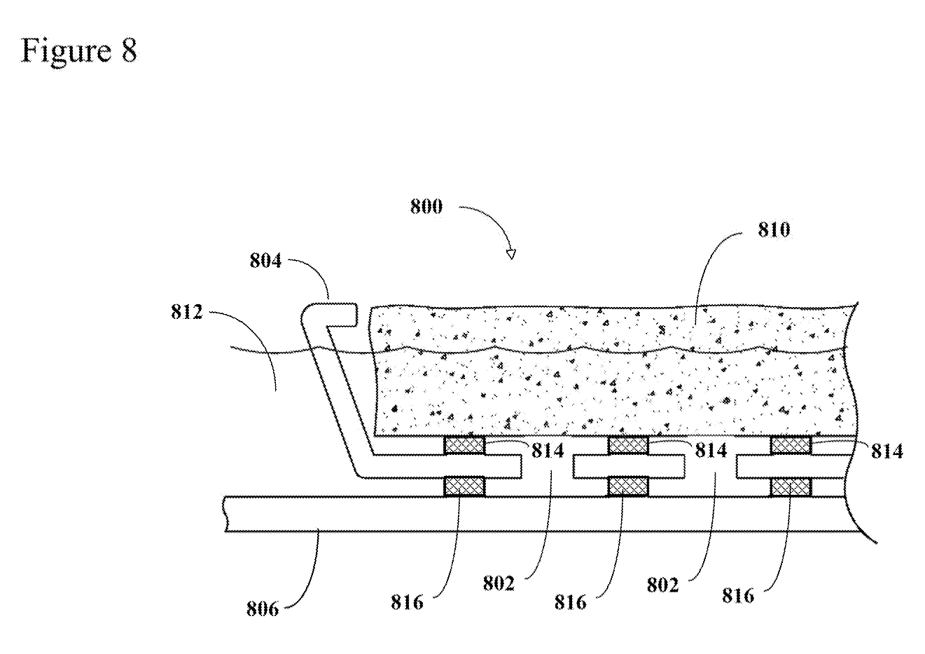

FIG. 8 shows a cross-sectional view of a portion 800 of a tray 804 in accordance with some embodiments. Like portion 400 of FIG. 4, portion 800 includes a nutrient medium 810, a portion of a base 806 and drip holes 802 that enable a nutrient medium 812 to be refreshed and drained from tray 804. In this embodiment, spacers 814 provide a space between growth substrate 810 and grow tray 804. Spacers 816 provide space between tray 804 and base 806. Spacers 814 and 816 may be incorporated into, attached to or simply separate components than growth matrix 810, tray 804 and grow bed 806. It should be understood that the configurations of corrugations and spacers illustrated in FIGS. 1-5, 7 and 8 are merely a few examples of means to create space between a growth matrix and tray and between a tray and a grow bed. Those with skill in the relevant arts should be able to devise many different ways to achieve the same result.

References to “one embodiment”, “an embodiment”, “a particular embodiment”, “example embodiments”, “some embodiments”, and the like, indicate that a particular element or characteristic is included in at least one embodiment of the invention. Although the phrases “in one embodiment”, “an embodiment”, “a particular embodiment”, “example embodiments, “some embodiments”, and the like, may appear in various places, these do not necessarily refer to the same embodiment.

The above discussion is meant to be illustrative of the principles and various embodiments of the present invention. Numerous variations and modifications will become apparent to those skilled in the art once the above disclosure is fully appreciated. For example, Dimensions of the various elements may be varied to accommodate different deployment environments. It is intended that the following claims be interpreted to embrace all such variations and modifications.

We claim:

1. An apparatus, comprising:
a tray; having an interior bottom surface and an exterior bottom surface;
a plurality of drip holes disposed within a bottom portion of the tray, the drip holes passing from the exterior bottom surface of the bottom portion of the tray through to the interior bottom surface;
a support matrix;
a plurality of spacers configured to suspend the support matrix above the interior bottom surface, forming an space between the support matrix and the interior bottom surface; and
a dome defining an interior volume, the dome disposed above the tray and removably attached thereto; wherein:
the interior volume is configured to accommodate a plurality of plants growing within the apparatus;
and the support matrix is configured to support roots of the plurality of plants and convey a nutrient medium to the roots.

2. The apparatus of claim 1, wherein the plurality of spacers are incorporated into the support matrix.

3. The apparatus of claim 1, the dome comprising a plurality of vents.

4. The apparatus of claim 3, the plurality of vents comprising:
a plurality of lower vents; and
a plurality of upper vents, wherein the plurality of upper vents are positioned above the plurality of lower vents.

5. The apparatus of claim 1, further comprising:
a grow bed; and
a plurality of second spacers, wherein the plurality of second spacers are configured to suspend the tray above the grow bed.

6. The apparatus of claim 5, wherein the plurality of second spacers incorporated into the grow bed.

7. The apparatus of claim 4, the grow bed comprising:
a drain hole; and
a removable plug configured to fit within the drain hole.

8. An apparatus, comprising:
a grow bed;
a tray, the tray comprising:
an interior bottom surface;
an exterior bottom surface;
a plurality of drip holes disposed within a bottom portion of the tray, the drip holes passing from the exterior bottom surface through to the interior bottom surface,
a support matrix;
a plurality of first spacers, wherein the plurality of first spacers are configured to suspend the support medium above the exterior bottom portion, forming a space between the support matrix and the interior bottom surface;
a plurality of second spacers, wherein the plurality of second spacers are configured to suspend the tray above the grow bed, forming a space between the exterior bottom surface and an interior surface of the grow bed;
a dome defining an interior volume, the dome disposed above the tray and removably attached thereto; wherein:
the interior volume is configured to accommodate a plurality of plants growing within the apparatus;
and the support matrix supports roots of the plurality of plants and conveys a nutrient medium to the roots.

9. The apparatus of claim 8, wherein the plurality of first spacers are incorporated into the growth matrix.

10. The apparatus of claim 1, wherein the plurality of second spacers are incorporated into the grow bed.

11. The apparatus of claim 8, the grow bed comprising:
a drain hole; and
a removable plug configured to fit within the drain hole.

12. The apparatus of claim 8, the tray further comprising a plurality of vents within the dome.

13. The apparatus of claim 12, the plurality of vents comprising:
a plurality of lower vents; and
a plurality of upper vents, wherein the plurality of upper vents are positioned above the plurality of lower vents.
